(19) United States
(12) Patent Application Publication
(10) Pub. No.: US 2013/0321415 A1
(43) Pub. Date: Dec. 5, 2013

(54) Analytical Model Information Delivery Device and Analytical Model Information Delivery Program

(71) Applicants: Yuki Itabayashi, Hitachi (JP); Ichiro Nishigaki, Ishioka (JP); Masayuki Hariya, Kasumigaura (JP); Ichiro Kataoka, Kashiwa (JP)

(72) Inventors: Yuki Itabayashi, Hitachi (JP); Ichiro Nishigaki, Ishioka (JP); Masayuki Hariya, Kasumigaura (JP); Ichiro Kataoka, Kashiwa (JP)

(21) Appl. No.: 13/983,425

(22) PCT Filed: Feb. 22, 2011
(86) PCT No.: PCT/JP2011/053846

§ 371 Date: Aug. 2, 2013

(51) Int. Cl. G06T 17/00

(52) U.S. Cl. CPC G06T 17/00
USPC 345/420

(57) ABSTRACT

Using this analytical model information delivery device, it is possible to quickly create analytical models even when the designer and the analyst are different people. This analytical model information delivery device is provided in a device for creating numerical models from CAD data. A shape search unit searches the components making up the CAD data and extracts features, and matches the extracted features with shape creation rules pre-registered in an analytical modeling means database. Further, when modifying a three-dimensional CAD model using the shape creation rules, an input result display unit highlights the modification area of the three-dimensional CAD model modified in accordance with the shape creation rules. A model conversion unit creates a numerical model from the modified three-dimensional CAD model. A shape processing unit further interactively modifies the modified area of the numerical model displayed by a modeling area display unit.

### TECHNICAL FIELD

The present invention relates to an analytical model information delivery device and an analytical model information delivery program for, when creating an analytical model from a three-dimensional CAD model for design, delivering necessary information to an analyzer.

### BACKGROUND ART

Automatic creation of mesh data and shape simplification data required for CAE analysis from design data created, for example, by three-dimensional CAD leads to reduced time for model creation and analysis. There are cases in which analytical data is created jointly by a designer and an analyzer respectively undertaking divided work portions. In such cases, it is necessary that the analyzer makes numerical analysis in line with the designer's intent. There have, however, been cases in which an analytical model for analysis use is created by an analyzer without understanding the designer's intent consequently making it necessary for the analyzer to ask for reconfirmation by the designer about a modeling means or consequently causing failure in analysis work or making redoing of analysis work necessary. This results in using a large amount of time for analysis.

An example of operation time reduction achieved by creating an analytical model is described in Patent Literature 1. In the analytical model creation device described in the patent publication, data on a first part and a second part is included in CAD data. A weld bead search unit searches for a portion where a weld bead is to be formed, and a gap checking unit checks a gap by comparing the angle formed between the first part and the second part against the interplane angle threshold data. Based on the check result, a virtual shape creation unit creates a virtual shape in the gap and, based on weld bead leg length data, a weld bead creation unit creates a weld bead in the virtual shape. When the weld operation has been analyzed as described above, the CAD data including the weld bead thus created is stored in a CAD data storage unit.

In Patent Literature 2, a design support program is described which has a basic shape extraction unit for extracting basic shape data, a knowhow extraction unit for extracting knowhow data, and a relevance setting unit for relating model data and knowhow data so as to make easy, when applying a model used by a designer in the past, determining whether or not to apply a basic shape used in the model. In this way, when applying past models, the designer can easily know of knowhow concerning individual past models and can easily determine whether or not to apply basic shapes used in the past models.
Patent Literature 1: Japanese Patent Laid-Open No. 2010-262549
Patent Literature 2: Japanese Patent Laid-Open No. 2010-086476

### DISCLOSURE OF THE INVENTION

In the analytical model creation method disclosed in Patent Literature 1, the contact between a first part and a second part is made an object portion of welding, then the contact between the first part and the second part is automatically searched for and a line making up a common face between the two parts is presented to the user as additional welding information. In this method disclosed in Patent Literature 1, however, when different people are involved as an analyzer and a designer, respectively, it is possible that welding information not intended by the designer is added to cause an erroneous analytical model to be created. For example, there are cases in which, when creating an analytical model, the analyzer different from the designer creates an analytical model based on his/her own judgement without having necessary confirmation by the designer concerning phenomena or contents to be considered in a designing stage. When, in such cases, the designer's intent is known after analysis is carried out, it becomes necessary to correct the analytical model.

In the design support device according to Patent Literature 2, when applying past models, whether or not to apply basic shapes used in the past models is determined by considering models related with knowhow data. In this way, with the knowhow data being based on shapes used in the past, adequate consideration is not given to knowhow concerning new shapes. Hence, guidelines for creating an analytical model for a shape not used in the past cannot be easily obtained.

The present invention has been made in view of the defects of the existing techniques described above, and an object of the present invention is to enable speedy creation of an analytical model even when different people are involved as a designer and an analyzer, respectively. Another object of the present invention is to reduce errors in analytical model creation when different people are involved as a designer and an analyzer.

A characteristic of the present invention made to achieve the above objects is that an analytical model information delivery device is provided in a device for creating a numerical analytical model from CAD data and that the analytical model information delivery device includes: a CAD data read unit which reads CAD data and creates a three-dimensional CAD model; a shape search unit which searches elements included in the CAD data for a shape feature and stores the shape feature in a CAD feature shape database; a query unit which compares a result of searching made by the shape search unit against a shape creation rule prestored in an analytical modeling means database and instructs an input/output device to present the result of searching; an input result display unit which, responding to a query from the query unit, interactively corrects the result of searching the CAD data and instructs the input/output device to highlight a corrected portion of the corrected three-dimensional CAD model; a model conversion unit which creates a numerical analytic model from the corrected three-dimensional CAD model; a modeling portion display unit which instructs the input/output device to highlightedly display the corrected portion on the numerical analytical model; and a shape processing unit which further corrects interactively the corrected portion shown, by the modeling portion display unit, on the numerical analytical model.

In the above characteristic of the present invention, the shape search unit and the shape processing unit may be provided in different servers and, preferably, a name search unit is provided which, when the CAD data or the three-dimensional CAD model includes a name describing a shape feature, extracts the name and registers the extracted name in the CAD feature shape database.

Also in the above characteristic, when the shape creation rule stored in the analytical modeling means database is interactively corrected, the input result display unit preferably registers the corrected shape creation rule in the analytical modeling means database along with the name of the three-dimensional CAD model. Also, the analytical model information delivery device may have display means for displaying, when the modeling portion display unit issues an instruction to highlightedly display a corrected portion on the numerical analytical model, the corrected portion in a color different from the color in which other portions of the numerical analytical model are displayed.

Another characteristic of the present invention is that an analytical model information delivery device is provided in a device for creating a numerical analytical model from CAD data and searches three-dimensional CAD data for a feature shape and that the analytical model information delivery device includes: means for creating a three-dimensional CAD model from the three-dimensional CAD data; means for extracting a design parameter included in the shape of the three-dimensional CAD model; and means for comparing the extracted design parameter and a parameter pre-registered in a database and for, when the compared parameters are identical, correcting the numerical analytical model based on an interactively inputted determination condition.

A still another characteristic of the present invention made to achieve the above objects is that an analytical model information delivery program is installed in a device for creating a numerical analytical model from CAD data and that the program causes a computer to function as: a CAD data read unit which reads CAD data and creates a three-dimensional CAD model; a shape search unit which searches elements included in the CAD data for a shape feature and stores the shape feature in a CAD feature shape database; a query unit which compares a result of searching made by the shape search unit against a shape creation rule prestored in an analytical modeling means database and instructs an input/output device to present the result of searching; an input result display unit which, responding to a query from the query unit, interactively corrects the result of searching the CAD data and instructs the input/output device to highlight a corrected portion of the corrected three-dimensional CAD model; a model conversion unit which creates a numerical analytic model from the corrected three-dimensional CAD model; a modeling portion display unit which instructs the input/output device to highlightedly display the corrected portion on the numerical analytical model; and a shape processing unit which further corrects interactively the corrected portion shown, by the modeling portion display unit, on the numerical analytical model.

In the above characteristic of the present invention, the CAD data read unit, the shape search unit, and the input result display unit may be stored as one program in a server; and the model conversion unit, the modeling portion display unit, and the shape processing unit may be stored as one program in another server.

According to the present invention, a designer's knowhow can be conveyed to an analyzer via a common server or program, so that, even when different people are involved as a designer and an analyzer, respectively, an analytical model in line with the designer's intent can be created. It is, therefore, possible to reduce correction and redoing of work in creating an analytical model. This allows speedy creation of an analytical model. Since the analyzer different from the designer can create an analytical model in line with the designer's intent, errors in creating an analytical model can be reduced.

### BRIEF DESCRIPTION OF THE DRAWINGS

FIG. 1 is a schematic diagram of a design support system including an analytical model information delivery device according to the present invention.

FIG. 2 is a block diagram showing an embodiment of the analytical model information delivery device according to the present invention.

FIG. 3 is a flowchart of operation of the analytical model information delivery device shown in FIG. 2.

FIG. 4 is a specific operation flowchart of the analytical model information delivery device shown in FIG. 2.

FIG. 5 shows diagrams describing contents of the CAD feature shape database shown in FIG. 2.

FIG. 6 is a diagram describing contents of the analytical modeling means database shown in FIG. 2.

FIG. 7 is a diagram showing an example of operation screen used in the flow of operation shown in FIG. 3.

FIG. 8 is a diagram showing an example of operation screen used in the flow of operation shown in FIG. 3.

FIG. 9 is a diagram showing an example of operation screen used in the flow of operation shown in FIG. 3.

FIG. 10 is a diagram showing an example of operation screen used in the flow of operation shown in FIG. 3.

FIG. 11 is a diagram showing an example of operation screen used in the flow of operation shown in FIG. 3.

FIG. 12 is a diagram showing an example of operation screen used in the flow of operation shown in FIG. 3.

FIG. 13 is a diagram showing an example of operation screen used in the flow of operation shown in FIG. 3.

FIG. 14 is a diagram showing an example of operation screen used in the flow of operation shown in FIG. 3.

FIG. 15 is a diagram showing an example of operation screen used in the flow of operation shown in FIG. 3.

FIG. 16 is a diagram showing an example of operation screen used in the flow of operation shown in FIG. 3.

FIG. 17 is a diagram showing an example of operation screen used in the flow of operation shown in FIG. 3.

### BEST MODE FOR CARRYING OUT THE INVENTION

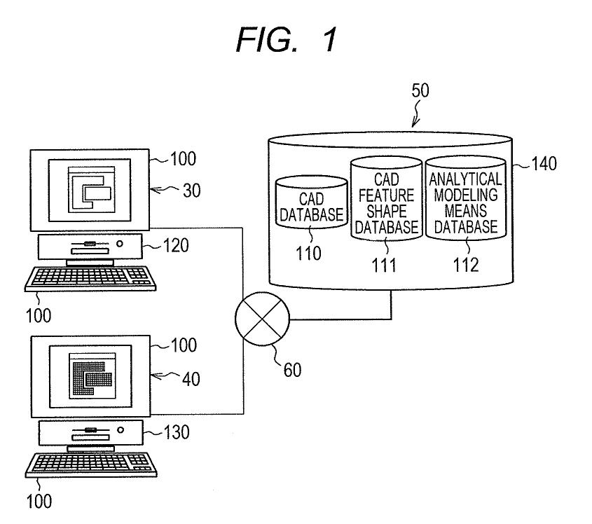

An embodiment of the analytical model information delivery device according to the present invention will be described below with reference to drawings. FIG. 1 is a schematic diagram of a design support system 50 including an analytical model information delivery device. A designer who creates a shape model and an analyzer who creates an analytical model based on the shape model and carries out analysis use different servers 30 and 40, respectively, and they both use a database stored in a large-capacity storage device 140 via a network (communication line).

The server 30 used by the designer stores three-dimensional CAD software and makes up a CAD model creation unit 120. The server 40 used by the analyzer stores analysis software and makes up an analytical CAD model read unit 130. Each of the servers 30 and 40 has an input/output device 100 and is provided with a keyboard and a mouse as input means and a display as an input/output means. As a network, a LAN or Internet is used. The storage device 140 stores a CAD database 110 containing CAD data representing geometric shapes of parts to be designed, a CAD feature shape database 111, and an analytical modeling means database 112, the last two being detailed later.

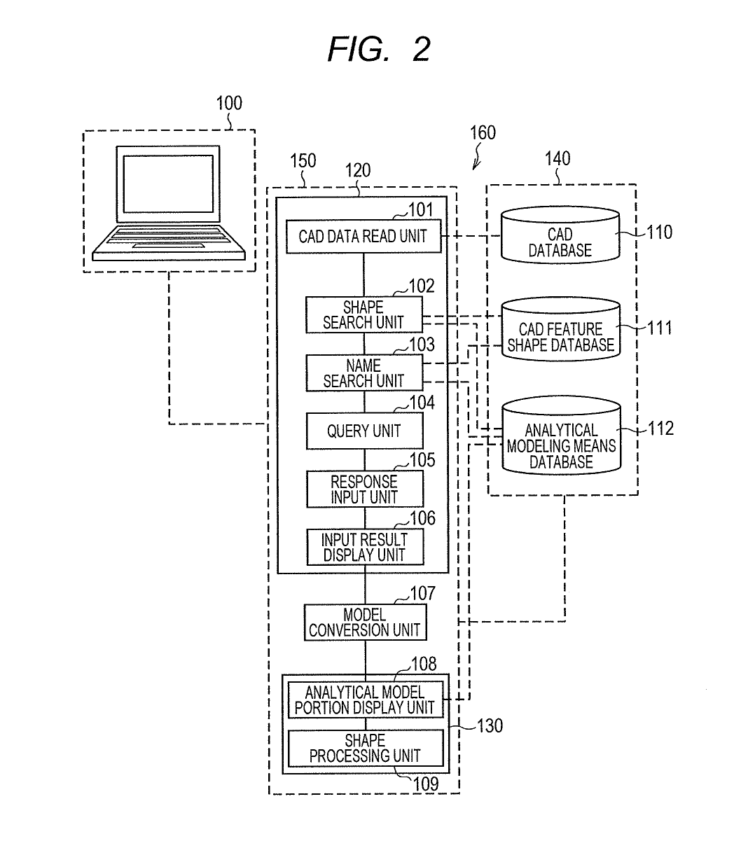

FIG. 2 is a block diagram showing an embodiment of an analytical model information delivery device 160 provided in the design support system 50 shown in FIG. 1. The analytical model information delivery device 160 is used by both the designer designing parts and the analyzer carrying out numerical analysis based on CAD models created by the designer. There are cases in which the analytical model information delivery device 160 is used first by the designer for designing, then by the analyzer for analysis and also cases in which it is used interactively by the designer and the analyzer.

The analytical model information delivery device 160 is normally a software program installed in one or more computers 150 which are computing devices. The computer 150 is provided with the input/output device 100 shown in FIG. 1. The computer 150 is provided with the large-capacity storage device 140 connected via the network 60 or directly. The storage device 140 stores, as described above, the CAD database 110, the CAD feature shape database 111, and the analytical modeling means database 112.

The computing device 150 is broadly comprised of the CAD model creation unit 120, the analytical CAD model read unit 130, and a model conversion unit 107 interposed between the CAD model creation unit 120 and the analytical model read unit 130. Obviously, though not described in connection with the present embodiment, analysis means for carrying out analyses, for example, stress analysis and flow analysis are included in the computing device 150.

The CAD model creation unit 120 includes a CAD data read unit 101, a shape search unit 102, a name search unit 103, a query unit 104, a response input unit 105, and an input result display unit 106. The CAD data read unit 101 reads CAD data, as input data, from the CAD data base 110 stored in the storage device 140 and creates a provisional three-dimensional CAD model. The shape search unit 102 searches the input CAD data for a feature shape, for example, a gap or a hole. At this time, the shape search unit 102 searches the CAD feature shape database 111 based on an interplane distance given by the CAD data when searching for a gap as a feature shape or based on information about a line making up a cylindrical plane or a circular arc given by the CAD data when searching for a hole shape as a feature shape.

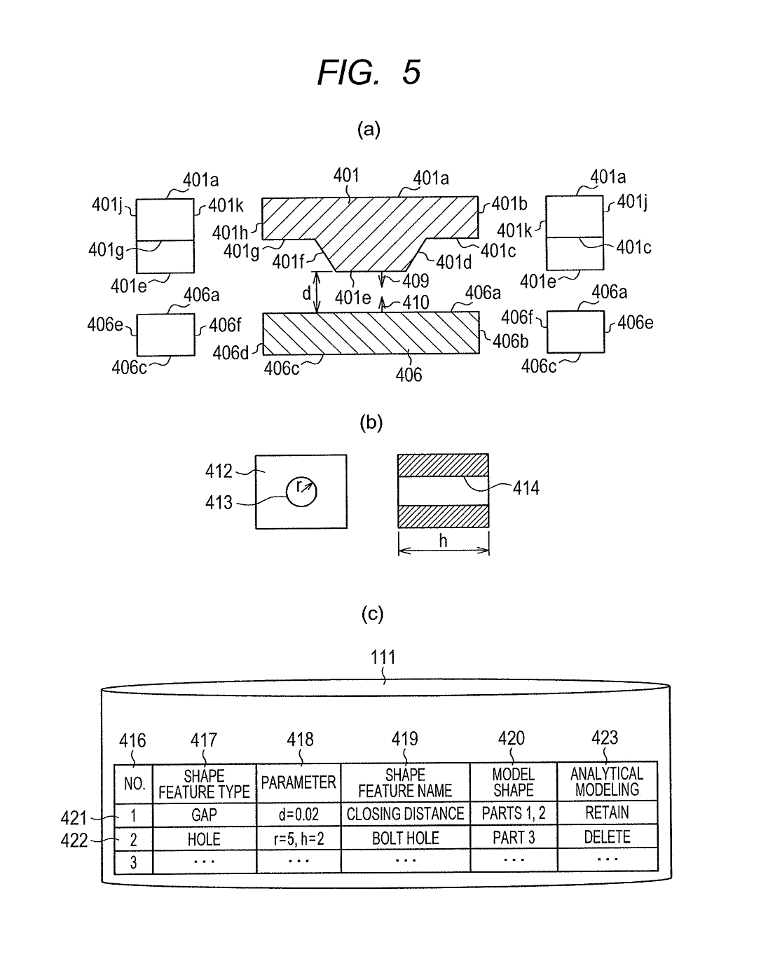

When the input CAD data is attached with a flag denoting a feature name label provided therein, i.e. indicating that the CAD data includes a feature, the name search unit 103 extracts the shape that, with the CAD model being finely complicated, cannot be searched for based on search conditions of the shape search unit 102. Such a shape is added, as part name/feature name label information (see FIG. 5(c)), to the data included in the CAD feature shape database 111.

The results, read by the shape search unit 102 and the name search unit 103, of searching the input CAD data are registered in the CAD feature shape database 111 and are outputted as an output list. The data included in the output list is compared against the determination conditions prestored in the analytical modeling means database 112. When the comparison finds that a determination condition is met, the query unit 104 included in the CAD model creation unit 120 makes a query for determination to be made by the designer (user of the analytical model information delivery device 160) taking analysis conditions into account.

The designer currently using the analytical model information delivery device 160 inputs, interactively from the response input unit 105 included in the CAD model creation unit 120, a response to the query from the query unit 104.

For example, in searching for a gap as a feature shape of the CAD model, when an interplane distance given by the CAD data is equal to or smaller than a threshold set as a determination condition and the shape search unit 103 determines that the interplane distance forms a gap, a query window appears, on the operation screen of the display included in the input/output device 100, at the object portion of the three-dimensional CAD model created from the CAD data. At this time, the object portion is highlighted. The user, i.e. the designer, then interactively inputs a response as to whether or not the object portion is a gap.

When, based on information about a cylindrical plane or a circular arc given by the CAD data, the shape search unit 102 determines that the object portion is a hole shape, the query unit 104 requests a response to be interactively inputted as to whether or not the object portion is to be represented as a hole in creating an analytical model. The response inputted from the response input unit 105 is reflected in the three-dimensional CAD model shown on the display included in the input/output device 100 via the input result display unit 106 included in the CAD model creation unit 120. At this time, only a minimum area of the object portion of the three-dimensional CAD model is highlighted.

The information inputted via the response input unit 105 updates, as new CAD model data, the CAD model. When the three-dimensional CAD model is updated and finalized in the CAD model creation unit 120, the model conversion unit 107 included in the computing device 150 converts the three-dimensional CAD model into an analytical CAD model.

The analytical CAD model obtained by conversion of the three-dimensional CAD model by the model conversion unit 107 is displayed on the operation screen of the display included in the input/output device 100 via an analytical modeling portion display unit 108 included in the analytical CAD model read unit 130. At this time, a minimum area of the analytical CAD model portion corresponding to the updated or corrected portion of the CAD model drawn out from the CAD database 110 is highlighted.

In this way, the analytical modeling means intended by the designer is interactively inputted to the analytical model information delivery device 160 for delivery to the analyzer to use the analytical model information delivery device 160 next. The analyzer carries out, while checking the information thus delivered, analytical modeling using a shape processing unit 109 included in the analytical CAD model read unit 130.

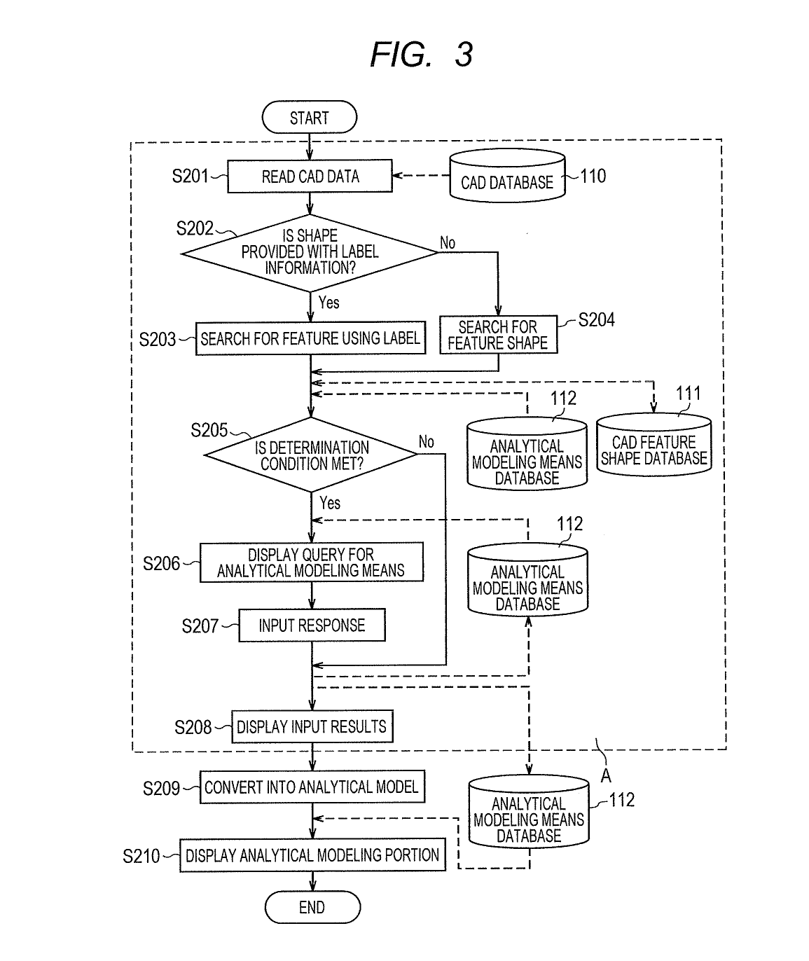

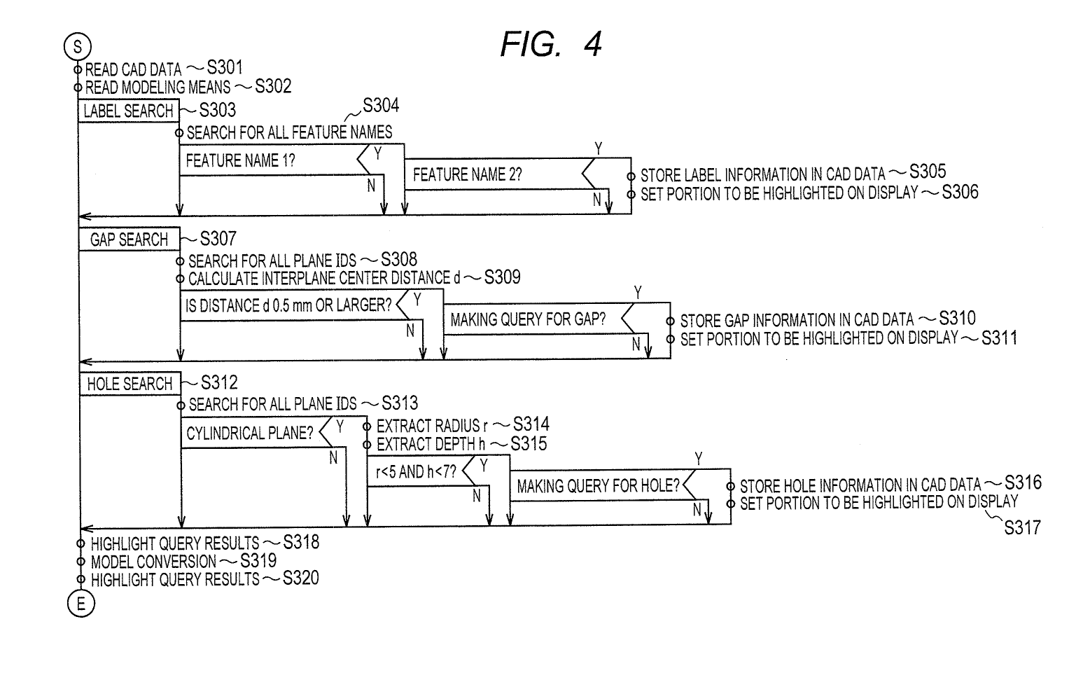

Concrete operation of the analytical model information delivery device 160 configured as described above will be described with reference to FIGS. 3 and 4. FIG. 3 is a flowchart of operation of the analytical model information delivery device 160 shown in FIG. 2. FIG. 4 is a more specific flowchart showing operation of the analytical model information delivery device 160 based on a concrete example.

FIG. 3 shows the flow of operation performed, based on the assumption that an analytical modeling means is used, to create a three-dimensional CAD model from the CAD data stored in the CAD database 110, to make the created three-dimensional CAD model undergo model conversion short of analytical model creation, and to display a portion to be made into an analytical model. The portion to which the analytical modeling means is to be applied is searched for and the analytical modeling means is set at the portion located by the search. The portion where the analytical modeling means is set is highlighted on the input/output device 100 via the analytical modeling portion display unit 108.

The CAD data read unit 101 reads CAD data as input data from the CAD database 110 and creates a provisional three-dimensional CAD model (step S201). The analytical model information delivery device 160 determines, in step S202, whether or not a label is attached to the input CAD data or to the shape of each part of the three-dimensional CAD model. When it is determined that the CAD data to be analyzed is attached with a label, the input CAD data or the three-dimensional CAD model is subjected, at name search 203, to feature searching based on label information (step S203).

In cases where it has been determined in step S202 that the shape of any part represented by the CAD data to be analyzed is not attached with any label, the shape search unit 102 searches the input CAD data or the three-dimensional CAD model for a shape feature such as a gap or a hole represented by the CAD data (step S204).

The results of searching performed in step S203 and step S204 are stored in the CAD feature shape database 111. Though omitted in FIG. 5(c), not only shape features but also features are stored in the CAD feature shape database 111. Also, though not shown in FIG. 3, the designer enters, based on the search results, guidelines for analytical modeling in the analytical modeling column (see FIG. 5(c)) of the CAD feature shape database 111. Next, the determination condition prestored in the analytical modeling means database 112 and the results of the above searches (S203 and S204) are compared, and the comparison results are reflected in the CAD feature database 111 (step S205) (not shown in FIG. 3).

Feature parts meeting the design guidelines entered in the CAD feature shape database 111 and the determination conditions stored in the analytical modeling means database 112 are displayed on the display of the input/output device 100. At the same time, the contents of the query to be made by the analytical modeling query unit 104 concerning each feature part and depending on the kind of analysis to be made are displayed (step S206).

The user, i.e. the designer, interactively inputs a response to the query displayed on the input/output device 100 (step S207). The inputted response is entered in the response column, not shown, of the analytical modeling means database 112. At the same time, the response is highlighted as the input results on the three-dimensional CAD model screen of the input/output device 100 (step S208). The above steps S201 to S208 are executed mainly in the CAD model creation unit 120 (step A).

The information set based on the response inputted in step S207 is applied to the three-dimensional CAD model. This is referred to as “embedding.” Next, in step S209, the finalized three-dimensional CAD model is converted into an analytical CAD model. This will be described in detail later. With the analytical CAD model created, the three-dimensional CAD model displayed on the display screen of the input/output device 100 is replaced by the analytical CAD model. On the analytical CAD model displayed on the input/output device 100, the above feature part and query part carried over from the three-dimensional CAD model are highlighted (step S210).

Next, feature part extraction will be described with reference to FIGS. 4 to 6. FIG. 4 is a flowchart of gap searching, hole searching and label searching performed against the CAD data on the three-dimensional CAD model to be analyzed. The CAD data prestored in the CAD database 110 is read (step S301). The modeling means prestored in the analytical modeling means database 112 is also read (step S302).

When the input CAD data is provided with label information, the label is searched (step S303). The input CAD data is searched, using all feature names, to determine the feature represented by the label (step S304). Namely, first whether feature name 1 is included or not is determined, next whether feature name 2 is included or not is determined, and so on. In this process, the determination conditions prestored in the modeling means are used for feature name verification. When a feature name is extracted, the content of the query to be made is determined based on the relationship between feature names. The data extracted by this search operation is registered and stored in the CAD feature shape database 111 (step S305) while being also set as the portion to be highlighted (step S306).

When the input CAD data is provided with no label information, the CAD data is searched based on feature shapes. For example, when a feature is a gap, the interplane distance is calculated, then gap searching is performed by comparing the calculated interplane distance against the gap distance determination conditions registered in the analytical modeling means database 112 (step S307). For example, when two parts, i.e. part 1 (401) and part 2 (406) shown in FIG. 5(a) are disposed close to each other, the specific numbers (each referred to as a “plane ID”) assigned to ten planes 401a to 401k of part 1 (401) and six planes 406a to 406f of part 2 (406) are searched for (step S308). Next, based on the plane IDs, the distances d (center distances between planes) between planes 401a to 401k and planes 406a to 406f are determined (step S309).

In determining the distances d between planes 401a to 401k of part 1 and planes 406a to 406f of part 2, the distance between plane 1 (plane ID 401a) of part 1 (401) and each of planes 406a to 406f of part 2 is determined along with normal vectors between part 1 and part 2, and this is done for every one of planes 401a to 401k in order of plane IDs. Namely, referring to a middle part of FIG. 5(a) showing sectional views of part 1 (401) and part 2 (406), normal vectors 409 and 410 of plane 401e of part 1 (401) and plane 406a of part 2 (406) are determined. At the same time, distance d between plane 401e and plane 406a is calculated. When the distance between plane 401e and plane 406a is within a threshold set as a determination condition or when the angle formed between the two normal vectors 409 and 410 is nearly 180 degrees, the portion is determined as a gap.

Each of the interplane center distances determined is compared against the determination condition included in the analytical modeling means database 112. Namely, whether each interplane distance d is 0.5 mm or larger is determined. When an interplane center distance is 0.5 mm or larger, whether or not to make a query for “gap” is determined based on the above determination condition. When making a query for “gap,” the “gap” information is registered and stored in the CAD feature shape database 111 (step S310). At the same time, the portion to be highlighted on the display is set (step S311).

The CAD feature shape database 111 stores feature shape data included in the CAD data in a table format. As shown in FIG. 5(c), the table format includes, arranged along the row direction thereof, a number column 416, a shape feature type column 417, a parameter column 418, a shape feature name column 419, a model shape column 420, and an analytical modeling column 423. These item columns 416 to 422 and 423 store feature shape parameters. When a feature is a gap, the first row 421 stores “Gap,” “d=0.02” as gap distance, “Closing distance,” and “Parts 1, 2” as component information. The analytical modeling column 423 stores “Retain” interactively inputted at the time of analytical model creation as information as to whether or not to retain the gap as it is.

When the feature shape is a hole, a hole search is performed (step S312). The hole search is performed based on information about a line making up a cylindrical plane forming a hole or making up a circular arc at a peripheral edge of a hole, and such information is compared against the determination condition included in the modeling means. For example, when there is a through-hole 413 with radius r and depth h formed through part 3 (412) as shown in FIG. 5(b), the plane IDs of the six side planes and one cylindrical plane 414 of part 3 (412) are searched for (step S313). Then, whether or not such planes are cylindrical planes is determined.

When the plane 414 is determined as a cylindrical plane, radius 314 is extracted as r (step S314) and depth 315 is extracted as h (step S315). The data extracted is then compared against the determination conditions included in the modeling means so as to determine the content of the query to be made. For example, whether or not radius r meets the condition of r<5 and whether or not depth h meets the condition of h<7 are determined. When the radius and depth meet the corresponding conditions, whether or not to determine the portion as a hole based on the above determination conditions and make a query is determined. When making a query for hole, the gap information is registered and stored in the CAD feature shape database 111 (step S316). At the same time, the portion to be highlighted on the display is set (step S317).

The second row data 422 included in the CAD feature shape database 111 shown in FIG. 5(c) includes hole information as a shape feature. Namely, the shape feature type column 417 stores “Hole;” the parameter column 418 stores “r=5, h=2” as radius r and depth h, respectively; the shape feature name column 419 stores “Bolt hole;” and the model shape column 420 stores “Part 3” as component information. The analytical modeling column 423 stores “Delete” as modeling information meaning the hole is to be deleted. This information is reflected at the time of analytical model creation.

The content of the response to the query made as a result of the above search operation is highlighted on the operation screen of the input/output device 100 (step S318). This makes it possible to convert the three-dimensional CAD model into an analytical CAD model, so that model conversion is performed (step S319). Subsequently, as on the three-dimensional CAD model displayed on the screen, the query results are highlighted on the analytical CAD model displayed on the operation screen (step S320). Thus, the designer's intent is reflected in the analytical CAD model shown on the screen viewed by the analyzer. The information about analytical modeling is stored as the contents of modeling after the query about analytical modeling is made as described above. The table to be stored in the CAD feature shape database 111 may be stored in a state of being connected to the CAD data so as to allow the table to be referred to at the time of analytical model creation.

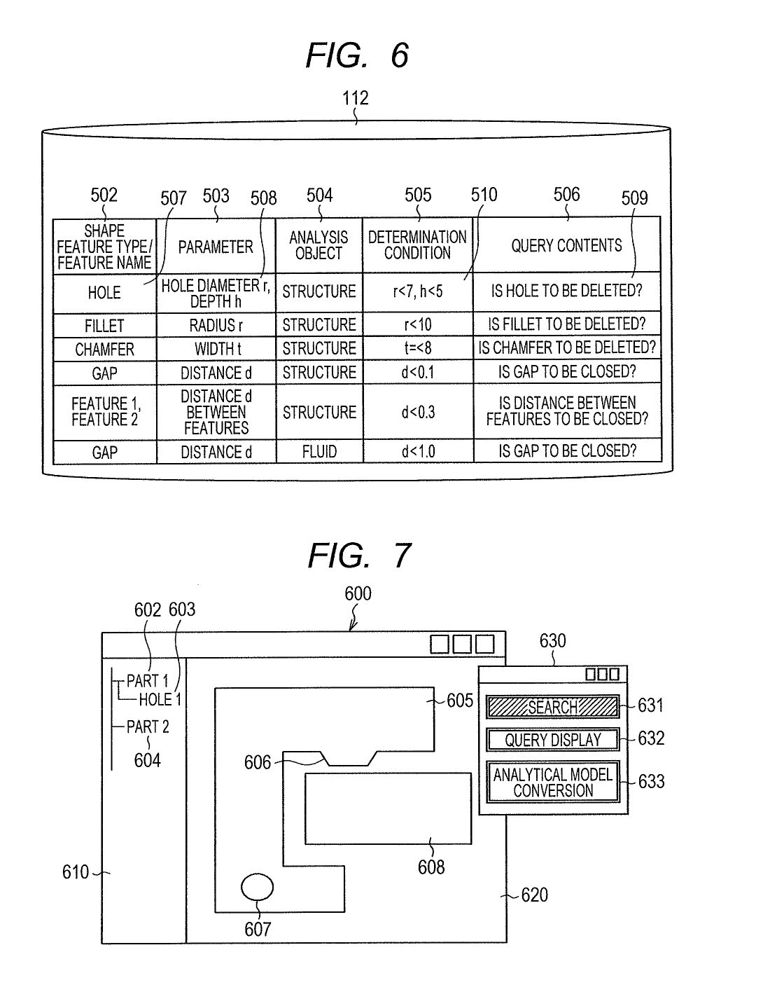

With reference to FIG. 6, an analytical modeling means will be described. FIG. 6 shows example contents of the analytical modeling means database 112. The analytical modeling means database 112 stores the determination conditions based on which interactive queries about how to model feature shapes in creating analytical models can be sent to an analyzer. The table stored in the analytical modeling means database 112 includes, arranged along the row direction, a shape feature type/feature name column 502, a parameter column 503, an analysis object column 504, a determination condition column 505, and a query contents column 506.

For the feature shapes extracted from CAD data, the analytical model information delivery device 160 checks whether or not the feature shape parameter information 418 stored in the CAD feature shape database 111 meets the feature shape determination conditions stored in the analytical modeling means database 112.

Namely, using the CAD feature shape database 111, it is checked, in order of numbers entered in the number column 416, whether or not the feature shapes extracted from the CAD data or the three-dimensional CAD model each meet the means registered in the analytical modeling means database 112. For each feature shape meeting the determination condition, the query information is displayed on the operation screen of the input/output device 100.

For example, when, in the first row, “Hole” is entered in the data field 507 of the shape feature type/feature name column 502, “Hole diameter r, depth h” is entered in the parameter field 508 meaning it is necessary to determine whether or not the hole diameter r and depth h meet the predetermined conditions. The predetermined conditions are “r<7, h<6” mm entered in the predetermined condition field 510. Therefore, when the hole diameter r and depth h are within the values entered in the determination condition field 510, i.e. when r<7 mm and h<5 mm, “Is hole to be deleted?” entered in the query content field 509 is displayed on the operation screen of the input/output device 100 so as to give the query to the analyzer interactively. In the present embodiment, hole information is registered in the second row that is numbered “2” in the CAD feature shape database 111. According to the hole information, the hole diameter is 5 mm and height is 2 mm, so that the hole meets the determination condition 510 included in the modeling means for holes represented by analytical modeling information. This causes message 509 reading “Is hole to be deleted?” to be displayed on the operation screen.

In the following, based on the operation screen displayed on the display included in the input/output device, processing performed according to the present invention will be described more specifically. FIG. 7 shows an example display on a first operation screen 600. The first operation screen 600 is comprised of a three-dimensional CAD screen 620 on the right-hand side where a drawing such as a three-dimensional CAD drawing or an analytical CAD drawing is shown and a part name/feature part 610 where components and features of the analysis object based on which the three-dimensional CAD drawing has been plotted are shown.

The first operation screen 600 is used when searching the three-dimensional CAD data to find feature shapes and feature names based on feature shape and feature name information. In the part name/feature part 610, part 1 (602), hole 1 (603) which is a feature name of part 1, and part 2 (604) included in the three-dimensional CAD screen 620 are shown in a tree structure.

In the three-dimensional CAD screen 620, drawings of part 1 (605) and part 2 (608) for three-dimensional CAD are shown. In the present embodiment, with part 1 (605) being a two-dimensionally U-shaped part and part 2 (608) being a rectangular parallelepiped part, only their front views are shown. Part 1 (605) has a projecting portion 606 and a hole-shaped portion 607. The relative positions of part 1 (605) and part 2 (608) to each other are shown to be identical to their actual relative positions.

In addition to the three-dimensional CAD screen 620, an operation menu window 630 is shown. The operation menu window 630 includes a search button 631, a query display button 632, and an analytical model conversion button 633. When the designer using the analytical model information delivery device 160 clicks the search button 631 on the operation menu window 609, the search button 631 is highlighted (as shown in FIG. 7).

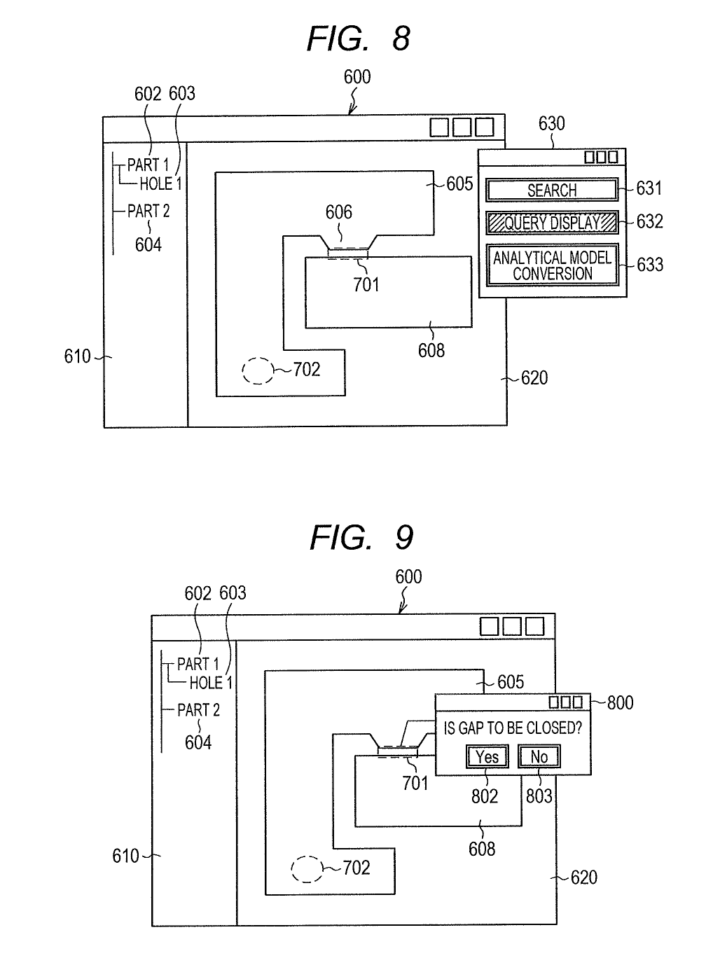

The analytical model information delivery device 160 selects, according to step S204 described above, feature shapes based on the feature shape/feature name information and, by comparing the information stored in the CAD feature shape database 111 against the rules given by the analytical modeling means database 112, extracts features of the CAD data or three-dimensional DAC model. The results of extraction are highlighted on the display. Upon completion of the processing of step S205, the user, i.e. the designer, clicks the query display button 632 on the operation menu window 630. The operation menu window in this state is shown in FIG. 8. As shown in FIG. 8, the query display button 632 is highlighted.

Referring to FIG. 8, only a minimum area of the portion determined as a gap 701 based on the shape of the projecting portion 606 of part 1 (605) and the shape of part 2 (608) is highlighted. Also, the portion determined as a hole 702 based on the hole-shaped portion of part 1 (605) or based on feature name information, hole 1 (603), about part 1 (605) is highlighted similarly to the gap 701.

Pressing the query display button 632 causes the analytical model information delivery device 160 to replace, on the first operation screen 600 of the input/output device 100, the operation menu window 630 with a query window 800 on which “Is gap to be closed?” is shown. The query window 800 is provided with a Yes button 802 and a No button 803 for use by the user in responding to the query. FIG. 9 shows the first operation screen 600 in a state before the query is responded to by the user.

The query window 800 showing “Is gap to be closed?” concerns the portion determined as a gap in the foregoing step S205. Namely, the display on the query window 800 changes depending on the content of the query. The content of the query is created when the information registered in the CAD feature shape database 111 and the analytical modeling means database 112 are searched in step S204.

When the user, i.e. the designer, presses the Yes button 802 responding to the query shown on the query window 800, the information about whether or not analytical modeling for analytical model creation is required is stored in the CAD feature shape database ill. Conversely, if the designer presses the No button 803, the portion is determined as a gap. The portion determined as a gap is highlighted (see step S318). Whether or not to close the gap is determined by the analyzer after the analytical model is created by conversion.

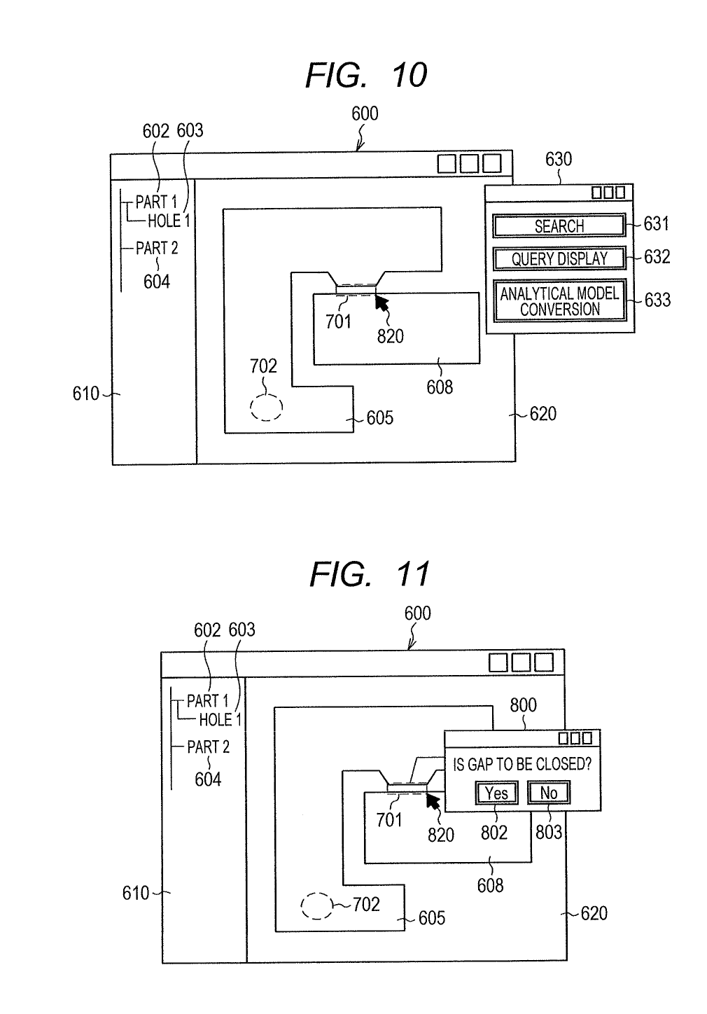

FIGS. 10 and 11 each show the first operation screen 600 on which a mouse pointer 820 is shown denoting a feature point in the CAD data. FIG. 10 corresponds to FIG. 8 showing the query display button 632 already clicked. In FIG. 10, the query display button 632 has not yet been clicked. In the other respects, FIG. 8 and FIG. 10 are identical to each other. FIG. 11 corresponds to FIG. 9 and, FIGS. 9 and 11 are identical to each other except that the mouse pointer 820 is shown in FIG. 11. By moving the mouse pointer 820 to a highlighted portion on the display, the user can interactively select a portion to be the object of a query.

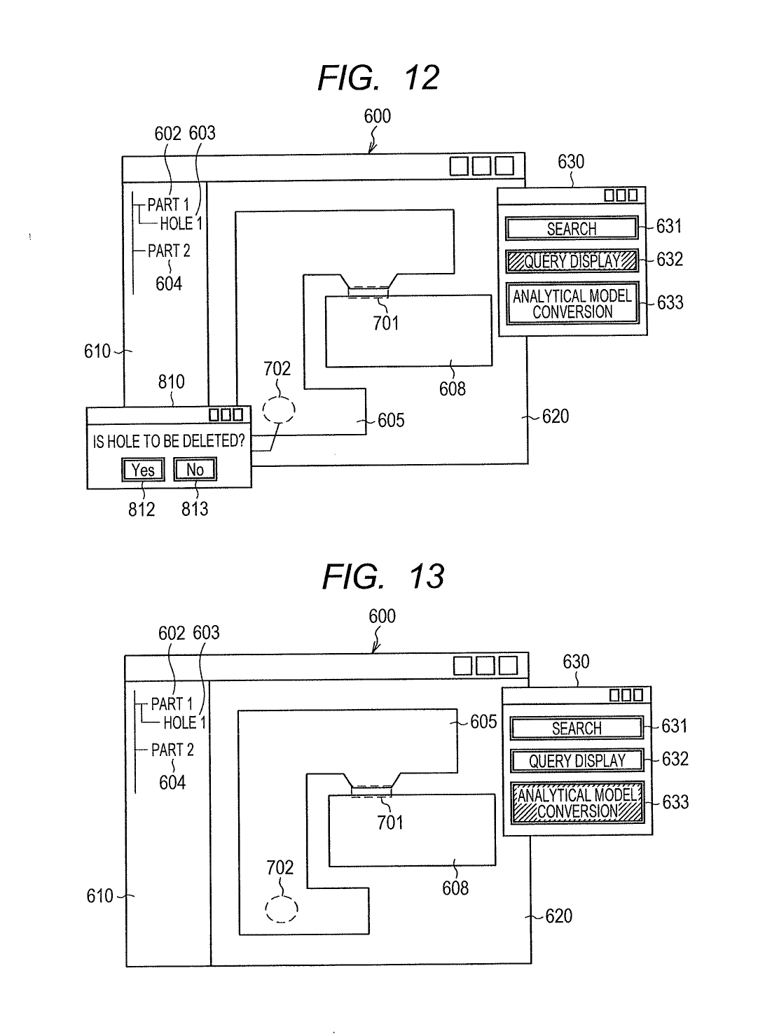

FIG. 12 shows the first operation screen 600 on which a query made by the analytical model information delivery device 160 for a hole 702 which is a feature formed in part 1 (605) is shown. Except that the query shown on a query window 810 is “Is hole to be deleted?,” the query window is identical to the query window displayed concerning the gap 701. The query window 810 is also provided with a Yes button 812 and a No button 813 for use by the user in responding to the query. The operation menu window 630 is also displayed on the first operation screen 600. When the user, i.e. the designer, clicks the Yes button 812 responding to the query, information about the analytical modeling means is added. If the designer clicks the No button 813, it is determined that the hole is reproduced in the analytical model. The portion determined to be reproduced is highlighted.

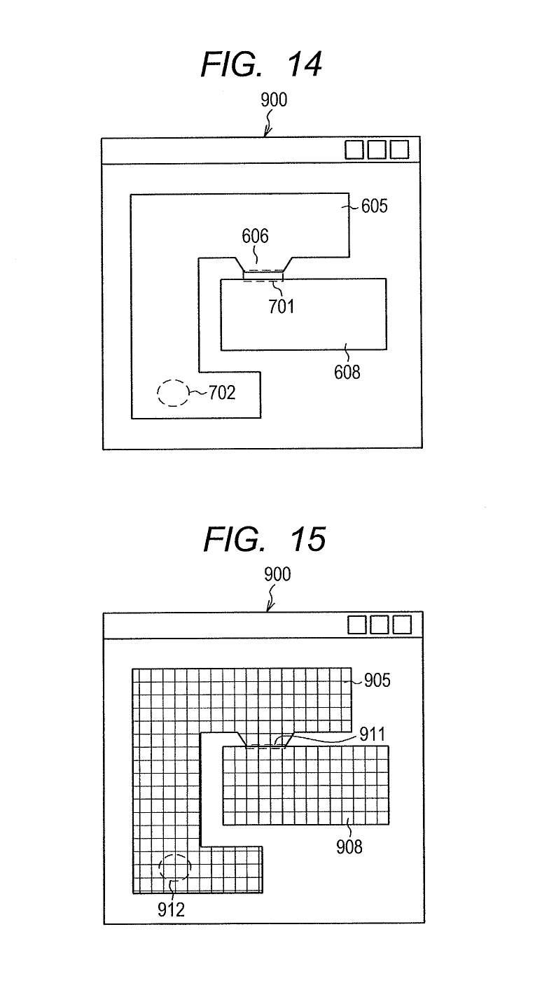

With creation of the three-dimensional CAD model completed in step S208, the three-dimensional CAD model is converted into an analytical model. FIG. 13 shows an example of the first operation screen 600 being used for model conversion into an analytical model. When the designer presses an analytical model conversion button 633 on the operation menu window 630, the three-dimensional CAD screen changes to a second operation screen 900, shown in FIG. 14, where analysis software can be started.

When the analysis software is started, the shape of the three-dimensional CAD model embedded with the information interactively received in response to the query from the analytical model information delivery device 160 is displayed as an analytical model outline on the second operation screen 900. The information received as a response is stored in the CAD feature shape database 111.

To generate, based on the three-dimensional CAD model, an analytical model overlapped with a mesh, the mesh is generated using the analysis software. This is shown in FIG. 15. The information set by the designer by interactively responding to the query from the analytical model information delivery device 160 is retained even after the mesh is generated, so that the results of modeling can be checked. Since, in the foregoing step S207, the Yes button 802 was clicked responding to the query “Is gap to be closed?,” the gap 911 between part 1 (905) and part 2 (908) is shown closed on the second operation screen 900. Since, for the hole 912, the Yes button 812 was clicked responding to the query “Is hole to be deleted?,” the hole is deleted on the second operation screen 900. At this time, both the hole and gap portions are highlighted.

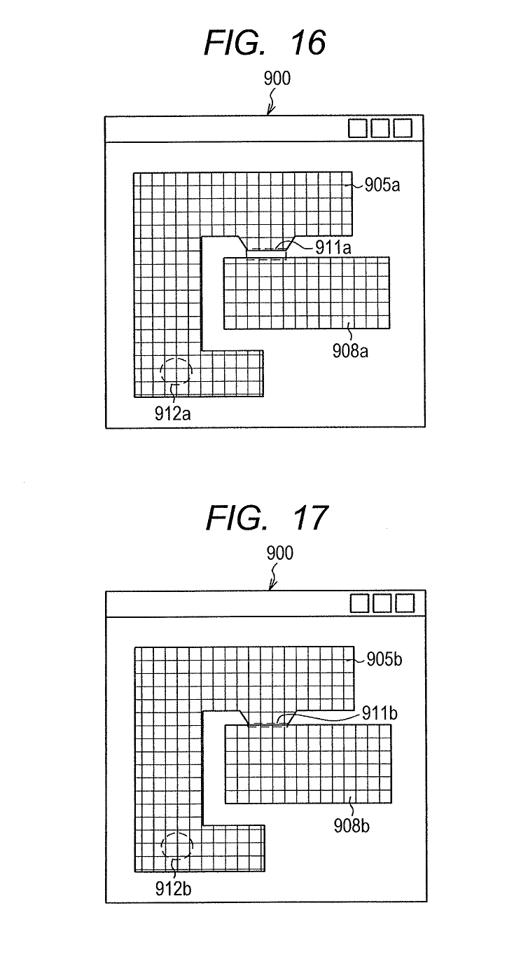

FIG. 16 shows an example of the second operation screen 900 shown after, in the foregoing step S207, the No button 813 was clicked responding to the query “Is gap to be closed?” and the query “Is hole to be deleted?” was responded to by clicking the Yes button 812. On the second operation screen 900, a gap 911a is shown between part 1 (905) and part 2 (908). Also, the hole 912a is deleted. At this time, both the gap and hole portions are highlighted.

FIG. 17 shows an example operation screen with a mesh generated by the analysis software. The information set by the designer by interactively responding to queries using CAD software is retained even after the mesh is generated, so that the analytical modeling means can be checked. The second operation screen 900 shows the gap closed when the mesh was generated even though the query “Is gap to be closed?” was responded to by clicking the No button 812. In a case like this in which an erroneous operation has caused disagreement between the modeling means and the results of mesh generation, the incorrect portion is highlighted.

In the above embodiment, an analytical CAD model is created from a three-dimensional CAD model by applying an analytical modeling means to gaps and holes. In the process, creation of an analytical CAD model embedded with data unique to the model to be analyzed is supported. This makes it possible to reduce reconfirmation work in which the analyzer asks the designer for reconfirmation about a modeling means and to reduce failure in analysis work or redoing of analysis work. Furthermore, since data management can be consolidated, data management becomes easier compared with cases in which information about gaps or hole shapes is given using drawings on paper, so that the occurrence of missing instructions and erroneous instructions can be prevented.

Furthermore, in the above embodiment, creation of the analytical CAD model is supported by shape searching and name searching to find portions requiring application of an analytical modeling means. It may also be considered to support model creation using knowhow based on past analysis results for similar parts or using material names used in past analyzed models. Such an approach may be effective when analyzing objects similar to objects analyzed in the past. When analyzing shapes not used in the past or when analyzing objects for different purposes than in the past or objects not analyzed in the past, however, the above approach can be used in fewer cases. According to the present invention, searching is performed making use of, not only geometrical features such as interplane distances between parts but also label information such as part names and feature names, so that supporting of analytical CAD model creation cannot be dominated by objects analyzed in the past. Still furthermore, since analytical modeling means suitable for analysis purposes can be selected for application, the present invention is effective in reducing failure in analysis work or redoing of analysis work.

As described in connection with the above embodiment, for a part portion meeting the determination condition included in the analytical modeling method, only a minimum area is highlighted on the display. In this way compared with cases where a whole surface portion meeting the determination condition is highlighted, the object portion meeting the determination condition becomes more conspicuous on the display. This makes it possible to prevent, for example, adding a feature in an area not requiring the feature or overlooking a portion among plural adjacent portions meeting the determination conditions. In an example method of highlighting only a minimum area of the object portion, when there are two planes A and B located close to each other, only the smaller one, for example, plane B, of the two planes is highlighted.

Even though, the above embodiment has been described using a hole and a gap as example features, the present invention can be applied to the processing of all types of features including not only holes and gaps but also fillets and chamfers, i.e., all types of features to be processed in working on products or in fabricating products.

### DESCRIPTION OF SYMBOLS

30, 40 Server
50 Design support system
60 Communication line (network)
100 Input/output device
101 CAD data read unit
102 Shape search unit
103 Name search unit
104 (Analytical modeling means) query unit
105 Response input unit
106 Input result display unit
107 Model conversion unit
108 Modeling portion display unit
109 Shape processing unit
110 CAD database
111 CAD feature shape database
112 Analytical modeling means database
120 CAD model creation unit
130 Analytical CAD model read unit
140 Storage device
150 Computing device (computer)
160 Analytical model information delivery device
401 Part 1
401a to 401k Plane
406 Part 2
406a to 406f Plane
409 Normal vector
410 Normal vector
412 Part 3
413 Circular arc
414 cylindrical plane
416 Number column
417 Shape feature type column
418 Parameter column
419 Shape feature name column
420 Model shape column
421 First row (row number 1)
422 Second row (row number 2)
423 Analytical modeling column
502 Shape feature type/feature name column
503 Parameter column
504 Analysis object column
505 Determination condition column
506 Query contents column
507 Data example
508 Data example
509 Data example
510 Data example
600 First operation screen
602 Part name field
603 Feature field
604 Part name field
605 First part
606 Projecting portion
607 Hole-shaped portion
608 Second part
610 Part name/feature part
620 Shape display part
630 Operation menu window
631 Search button
632 Query display button
633 Analytical model conversion button
701 Gap
702 Hole
800 Query window
802 Yes button
803 No button
810 Query window
812 Yes button
813 No button
820 Pointer
900 Second operation screen
905, 905b Mesh model of first part
908, 908b Mesh model of second part
911, 911b Gap portion
912, 912b Hole portion

1. An analytical model information delivery device provided in a device for creating a numerical analytical model from CAD data, comprising:
a CAD data read unit which reads CAD data and creates a three-dimensional CAD model;
a shape search unit which searches elements included in the CAD data for a shape feature and stores the shape feature in a CAD feature shape database;
a query unit which compares a result of searching made by the shape search unit against a shape creation rule prestored in an analytical modeling means database and instructs an input/output device to present the result of searching;
an input result display unit which, responding to a query from the query unit, interactively corrects the result of searching the CAD data and instructs the input/output device to highlight a corrected portion of the corrected three-dimensional CAD model;
a model conversion unit which creates a numerical analytic model from the corrected three-dimensional CAD model;
a modeling portion display unit which instructs the input/output device to highlightedly display the corrected portion on the numerical analytical model; and
a shape processing unit which further corrects interactively the corrected portion shown, by the modeling portion display unit, on the numerical analytical model.

2. An analytical model information delivery device which is provided in a device for creating a numerical analytical model from CAD data and which searches three-dimensional CAD data for a feature shape, comprising:
means for creating a three-dimensional CAD model from the three-dimensional CAD data;
means for extracting a design parameter included in the shape of the three-dimensional CAD model; and
means for comparing the extracted design parameter and a parameter pre-registered in a database and for, when the compared parameters are identical, correcting the numerical analytical model based on an interactively inputted determination condition.

3. The analytical model information delivery device according to claim 1, wherein the shape search unit and the shape processing unit are provided in different servers.

4. The analytical model information delivery device according to claim 1, comprising a name search unit which, when the CAD data or the three-dimensional CAD model includes a name describing a shape feature, extracts the name and registers the extracted name in the CAD feature shape database.

5. The analytical model information delivery device according to claim 1, wherein, when the shape creation rule stored in the analytical modeling means database is interactively corrected, the input result display unit registers the corrected shape creation rule in the analytical modeling means database along with the name of the three-dimensional CAD model.

6. The analytical model information delivery device according to claim 1, comprising display means for displaying, when the modeling portion display unit issues an instruction to highlightedly display a corrected portion on the numerical analytical model, the corrected portion in a color different from the color in which other portions of the numerical analytical model are displayed.

7. An analytical model information delivery program installed in a device for creating a numerical analytical model from CAD data, the program causing a computer to function as:
a CAD data read unit which reads CAD data and creates a three-dimensional CAD model;
a shape search unit which searches elements included in the CAD data for a shape feature and stores the shape feature in a CAD feature shape database;
a query unit which compares a result of searching made by the shape search unit against a shape creation rule prestored in an analytical modeling means database and instructs an input/output device to present the result of searching;
an input result display unit which, responding to a query from the query unit, interactively corrects the result of searching the CAD data and instructs the input/output device to highlight a corrected portion of the corrected three-dimensional CAD model;
a model conversion unit which creates a numerical analytic model from the corrected three-dimensional CAD model;
a modeling portion display unit which instructs the input/output device to highlightedly display the corrected portion on the numerical analytical model; and
a shape processing unit which further corrects interactively the corrected portion shown, by the modeling portion display unit, on the numerical analytical model.

8. The analytical model information delivery program according to claim 7, wherein: the CAD data read unit, the shape search unit, and the input result display unit are stored as one program in a server; and the model conversion unit, the modeling portion display unit, and the shape processing unit are stored as one program in another server.
